(19) United States
(12) Patent Application Publication
(10) Pub. No.: US 2026/0152669 A1
(43) Pub. Date: Jun. 4, 2026

(54) Light-Curable Adhesive Composition with Improved Bonding Performance to Low Surface Energy Substrates

(71) Applicant: Henkel AG & Co. KGaA, Duesseldorf (DE)

(72) Inventors: Andrew D. Messana, Newington, CT (US); Chih-Min Cheng, Westford, MA (US)

(21) Appl. No.: 19/408,689

(22) Filed: Dec. 4, 2025

Related U.S. Application Data
(63) Continuation of application No. PCT/US2024/031343, filed on May 29, 2024.
(60) Provisional application No. 63/507,166, filed on Jun. 9, 2023.
(60) Provisional application No. 63/647,869, filed on May 15, 2024.

(51) Int. Cl. C09J 4/06; B32B 7/12; B32B 25/04; B32B 25/08; B32B 25/14; B32B 27/30; B32B 27/36; C08F 283/12; C08J 5/12; C09J 151/08

(52) U.S. Cl. CPC C09J 4/06; B32B 7/12; C08F 283/124; C08J 5/128; C09J 151/085; B32B 25/042; B32B 25/08; B32B 25/14; B32B 27/304; B32B 27/365; B32B 2250/02; C08J 2321/00; C08J 2327/06; C08J 2369/00; C08J 2451/08

(57) ABSTRACT

Disclosed are one-part, light-curable adhesive compositions with improved bonding performance, their method of preparation and their use, particularly in applications requiring bonding to at least one low surface energy substrate; and in some embodiments the compositions include a polybutadiene urethane acrylate oligomer; optionally, a polyisobutylene (meth)acrylate oligomer; a (meth)acrylate monomer; a polyurethane acrylate oligomer; a photo-curing system; and a light-curable polydimethylsiloxane di-functional (meth)acrylate oligomer.

### FIELD

The present invention relates to one-part, light-curable adhesive compositions with improved bonding performance, their method of preparation and their use, particularly in applications requiring bonding to at least one low surface energy substrate. In some embodiments the compositions include a polybutadiene urethane acrylate oligomer; optionally, a polyisobutylene (meth)acrylate oligomer; a (meth)acrylate monomer; a polyurethane acrylate oligomer; a photo-curing system; and a light-curable polydimethylsiloxane di-functional (meth)acrylate oligomer.

### BRIEF DESCRIPTION OF RELATED TECHNOLOGY

Commercial applications, for example, but not limited to medical commercial applications which require tube-sets, tube bonding and the like, have been switching from traditional medium to high surface energy tubing materials such as polyvinylchloride to low surface energy substrates (“LSE's”). One of the many issues with traditional tubing materials relates to the potential of various harmful materials which may leach and/or be extractable subsequent to curing such tube-sets, tube bonding and the like. When using adhesives in connection with low surface energy substrates LSE's, a common issue in the industry is poor adhesion properties. LSE's generally include polyolefins such as polyethylene and polypropylene, thermoplastic elastomer (“TPE”) and thermoplastic urethane (“TPU”) materials.

The industry has conventionally used activators or primers or solvent-welding techniques to increase adhesion bond strength for LSE bonding applications. However, although these techniques can provide better adhesion properties, they possess certain shortcomings. Activators or primers are often solvent delivered and are a two-step (or “part”) process. Solvent-welding often requires harsh flammable and odorous solvents. Neither technique is optimal from a product safety perspective or product manufacturing perspective for use, for example, in medical device applications. Thus, there is a need to develop an adhesive for use in connection with LSE's which eliminates the safety concerns and minimizes the number of steps/parts required in forming the adhesive, thereby greatly improving the manufacturing process and sustainability of such adhesive.

Therefore, it would be advantageous to find a one-part adhesive that provides improved adhesion to LSE's and reduced safety risk.

### SUMMARY

The present compositions solve the problems of the prior art by producing one-part, light-curable adhesive compositions which subsequent to cure, exhibit high adhesion bonding properties when bonded to at least one LSE substrate without requiring the use of activators or primers. Advantageously, the present invention provides these properties in the absence of and without the need of monomeric isocyanate (meth)acrylates.

One advantageous aspect of the present invention includes, a one-part, light-curable adhesive composition which exhibits high adhesion properties when bonded to low surface energy thermoplastic substrate(s) subsequent to cure, including:
a) a polybutadiene urethane acrylate oligomer present in an amount of about 10% to about 60% by weight;
b) a (meth)acrylate monomer present in an amount of about 50% to about 75% by weight;
c) a polyurethane acrylate oligomer;
d) a photo-curing system; and
e) a light-curable polydimethylsiloxane di-functional (meth)acrylate oligomer.

Another advantageous aspect of the present invention includes a method of making a one-part, light-curable adhesive composition which exhibits high adhesion properties when bonded to LSE substrate(s) subsequent to cure, including the steps of:
a) combining a polybutadiene urethane acrylate oligomer present in an amount of about 10% to about 60% by weight; with
b) optionally, a polyisobutylene (meth)acrylate oligomer present in an amount of about 5% to about 15% by weight;
c) a (meth)acrylate monomer present in an amount of about 50% to about 75% by weight;
d) a polyurethane acrylate oligomer;
e) a photo-curing system; and
f) a light-curable polydimethylsiloxane di-functional (meth)acrylate oligomer.

Yet, another advantageous aspect of the present invention includes a process of depositing a one-part, light-curable adhesive composition which exhibits high adhesion properties when bonded to LSE substrate(s) subsequent to cure, including the steps of:
a) combining a polybutadiene urethane acrylate oligomer present in an amount of about 10% to about 60% by weight;
b) optionally, a polyisobutylene (meth)acrylate oligomer present in an amount of about 5% to about 15% by weight;
c) a (meth)acrylate monomer present in an amount of about 50% to about 75% by weight;
d) a polyurethane acrylate oligomer;
e) a photo-curing system; and
f) a light-curable polydimethylsiloxane di-functional (meth)acrylate oligomer;
g) depositing the composition on the substrate to form one or more of a seal, a coating or a bond; and
h) curing the composition by exposure to UV light.

### BRIEF DESCRIPTION OF THE FIGURES

FIG. 1 is a graphical representation of measured results of Tensile Lap Shear Strength tests conducted on various substrate pairings of polycarbonate and various TPEs.

FIG. 2 is a graphical representation of measured results of Tensile Lap Shear Strength tests conducted on various substrate pairings of polyvinylchloride and various TPEs.

FIG. 3 is a graphical representation of measured results of Tensile Lap Shear Strength tests conducted on various substrate pairings of TPEs to each other.

FIG. 4 is a graphical representation of measured results of Tensile Lap Shear Strength tests conducted on various substrate pairings of polycarbonate and various TPEs initially at room temperature, after 4 weeks with exposure to 60 degrees Celsius temperature, and after 4 weeks with exposure to 40 degrees Celsius temperature and 98% humidity.

FIG. 5 is a graphical representation of measured results of Tensile Lap Shear Strength tests conducted on various substrate pairings of TPEs to each other initially at room temperature, after 4 weeks with exposure to 60 degrees Celsius temperature, and after 4 weeks with exposure to 40 degrees Celsius temperature and 98% humidity.

FIG. 6 is a graphical representation of bond strength for different types of tubing bonded to a PVC fitting.

### DETAILED DESCRIPTION

### Definitions

The term “high surface energy” means materials with a surface energy of greater than about 38 mJ/m² (38 dynes/cm)

The term “light” is meant to include UV light, visible light and other electromagnetic radiation capable of producing a cure reaction in the disclosed composition. The non-limiting preferred actinic radiation wavelength (nm) is form about 200 to about 500 nm.

The term “low surface energy” means materials with a surface energy of about 0 mJ/m² to about 37 mJ/m² (0 to about 37 dynes/cm)

The term “(meth)acryloyl” includes both acryloyl and methacryloyl. So, for example, the term “(meth)acryloyl group” refers to the acryloyl group (H₂C═CH—C(═O)—) and the methacryloyl group (H₂C═C(CH₃)—C(═O)—) Includes both. Similarly, the term “(meth)acrylic” includes both acrylic and methacrylic.

The term “nano” means having a particle size in the range of about 1 nm to about 100 nm.

The contents of all documents disclosed herein are incorporated by reference in their entirety.

Polyolefins such as polypropylene, polyethylene and their copolymers are one class of Low Surface Energy (LSE) material. Thermoplastic elastomers (TPE's) are another class of low surface energy copolymers or a physical mix of polymers that possess materials with both thermoplastic and elastomeric properties. One advantage of using TPE's is that TPE's possess the advantages of commercial thermoplastics, but also possess the performance properties of elastomers. Another advantage of using TPE's are their ability to stretch and return to their near-original shapes.

Various types of TPE's are used commercially. In one advantageous aspect, useful TPE's include, but are not limited to, styrenic block copolymers (“TPS”), thermoplastic polyolefin elastomers (“TPO”), thermoplastic vulcanizates (“TPV”), thermoplastic polyurethanes (“TPU”), thermoplastic copolyester (“TPC”), thermoplastic polyamides (“TPA”), acrylic, soft polyvinyl chloride (“TPVC”), unclassified thermoplastic elastomers, (“TPZ”) and combinations thereof.

Useful examples of TPSs include, styrene-ethylene-propylene block copolymers (SEPs), styrene-ethylene-propylene-styrene block copolymers (SEPSs), styrene-ethylene-ethylene-propylene-styrene block copolymer (SEEPSs), S*-ethylene-ethylene-propylene-S* block copolymer (S* represents crosslinkable hard block)(S*EEPS*-Vs), styrene-butadiene-styrene block copolymer (SBSs), styrene-ethylene-butylene-styrene block copolymer (SEBSs), styrene-isoprene-styrene block copolymer (SISs), and combinations thereof.

A useful example of SEPSs includes, but is not limited to, vinyl-bond rich SEPS (VSEPSs).

A useful example of SEEPSs includes, but is not limited to, vinyl-bond rich SEEPS (VSEEPSs).

A useful example of SISs includes, but is not limited to, vinyl-bond rich SIS (VSISs).

In some embodiments the disclosed curable adhesive compositions can be used to bond high surface energy materials, for example engineered plastic, glass or metal. In some embodiments the disclosed curable adhesive compositions can be used to bond combination of high surface energy and low surface energy materials.

In one advantageous aspect, the adhesive composition of the present invention may be used to bond two low surface energy substrates or a low surface energy substrate and a high surface energy substrate.

In one advantageous aspect, an article of manufacture, including a first substrate surface and a second substrate surface, may be made by bonding said first and second substrate surfaces by cured reaction products of the disclosed compositions. In a further advantageous, the article of manufacture does not have a surface primer.

The article of manufacture may be any article where high adhesion bonding strength is useful. For example, the compositions may be employed for tube bonding, tube bonding in medical procedures which require tube bonding, and as medical tubing, catheter tubing, IV tubing, drug delivery tubing, drainage tubing, gas flow tubing, cardiac tubing, guidewire tubing, medical film, coronary tubing, peripheral and neurovascular tubing, shaft tubing, pump tubing, to name a few.

The applications of the compositions of this invention include, but are not limited to use as adhesives.

In a further advantageous aspect, the first and second substrates may comprise Medalist® thermoplastic elastomer commercially available from Teknor Apex Company, such as Medalist thermoplastic elastomer (MD53283), Medalist thermoplastic elastomer (MD12372), Versaflex™ thermoplastic elastomer (G2705N), Medalist thermoplastic elastomer (MD50278), Medalist thermoplastic elastomer (MD36165), Medalist thermoplastic elastomer (MD53253), Medalist thermoplastic elastomer (MD53263), Medalist thermoplastic elastomer (MD53268), Medalist thermoplastic elastomer (MD53273), Medalist thermoplastic elastomer (MD53278), Medalist thermoplastic elastomer (MD53283), Medalist thermoplastic elastomer (MD53288), Medalist thermoplastic elastomer (MD53293), Medalist thermoplastic elastomer (MD12337), Medalist thermoplastic elastomer (MD12342), Medalist thermoplastic elastomer (MD12352), Medalist thermoplastic elastomer (MD12362), Medalist thermoplastic elastomer (MD12368), Medalist thermoplastic elastomer (MD12372), Medalist thermoplastic elastomer (MD12382), polyvinylchloride (PVC), polycarbonate (PC), and combinations thereof.

In one advantageous aspect, the adhesive composition may be used in connection with at least one TPE, including Medalist thermoplastic elastomer (MD53283), Medalist thermoplastic elastomer (MD12372), Versaflex thermoplastic elastomer (G2705N), Medalist thermoplastic elastomer (MD50278), Medalist thermoplastic elastomer (MD36165), Medalist thermoplastic elastomer (MD53253), Medalist thermoplastic elastomer (MD53263), Medalist thermoplastic elastomer (MD53268), Medalist thermoplastic elastomer (MD53273), Medalist thermoplastic elastomer (MD53278), Medalist thermoplastic elastomer (MD53283), Medalist thermoplastic elastomer (MD53288), Medalist thermoplastic elastomer (MD53293), Medalist thermoplastic elastomer (MD12337), Medalist thermoplastic elastomer (MD12342), Medalist thermoplastic elastomer (MD12352), Medalist thermoplastic elastomer (MD12362), Medalist thermoplastic elastomer (MD12368), Medalist thermoplastic elastomer (MD12372), Medalist thermoplastic elastomer (MD12382), and combinations thereof.

### Polybutadiene Urethane Acrylate Oligomers

The disclosed compositions include a polybutadiene urethane acrylate oligomer. Useful polybutadiene urethane acrylate oligomers include, but are not limited to, di-functional polybutadiene acrylate resin (for example, Dymax Bomar BR-641E), di-functional acrylate resin (for example, Dymax Bomar BR-582E8), di-functional aliphatic polybutadiene urethane acrylate oligomer (for example, Bomar BR-640D), di-functional aliphatic polybutadiene urethane acrylate (for example, Bomar BR-641D), di-functional aliphatic polybutadiene urethane acrylate (for example, BR-643D), di-functional aliphatic polybutadiene urethane acrylate oligomer (for example, BR-643), polybutadiene acrylate resin (for example, Nisso PB TEAI-1000) polybutadiene methacrylate resin (for example, Nisso PB TE-2000) and combinations thereof.

In one particularly advantageous aspect, the polybutadiene urethane acrylate oligomer may be di-functional polybutadiene acrylate resin.

The polybutadiene urethane acrylate oligomer may be present in amounts of about 10% to about 60%, about 15% to about 60%, about 20% to about 60%, about 25% to about 60%, about 30% to about 60%, about 35% to about 60%, about 40% to about 60%, about 45% to about 60%, about 50% to about 60%, about 55% to about 60%, all percentages weight by total composition.

The polybutadiene urethane acrylate oligomer may be present in amounts of about 10% to about 50%, about 15% to about 50%, about 20% to about 50%, about 25% to about 50%, about 30% to about 50%, about 35% to about 50%, about 40% to about 50%, about 45% to about 50%, all percentages weight by total composition.

The polybutadiene urethane acrylate oligomer may be present in amounts of about 10% to about 40%, about 15% to about 40%, about 20% to about 40%, about 25% to about 40%, about 30% to about 40%, about 35% to about 40%, all percentages weight by total composition.

In one advantageous aspect, the polybutadiene urethane acrylate oligomer may be present desirably in the amount of about 10% to about 60% percentage weight by total composition.

### Polyisobutylene (Meth)Acrylate Oligomers

The compositions of the present invention optionally include a polyisobutylene (meth)acrylate oligomer.

In one advantageous aspect, the polyisobutylene (meth)acrylate oligomers may be a polyisobutylene with terminal or pendant functional groups that are reactive and curable by radiation. Examples of terminal and/or pendant functional groups that are reactive and curable by radiation includes, but are not limited to, those selected from the groups consisting of acrylate, methacrylate, vinyl, vinyl ether, propenyl, crotyl, allyl, silicon-hydride, vinylsilyl, propargyl, cycloalkenyl, thiol, glycidyl, aliphatic epoxy, cycloaliphatic epoxy, oxetane, itaconate, maleimide, maleate, fumarate, cinnamate esters, styrenic, acrylamide, methacrylamide, and chalcone groups.

Exemplary (meth)acrylate-functionalized polyisobutylene includes, but are not limited to, diallyl polyisobutylene, di(meth)acrylate polyisobutylene, and vinyl-terminal polyisobutylene. Representative polyisobutylene (meth)acrylate are described in U.S. Pat. No. 5,171,760 to Edison Polymer Innovation Corp., U.S. Pat. No. 5,665,823 to Dow Corning Corp, U.S. Pat. Nos. 9,512,247 and 9,708,424 to Kaneka Corporation; and U.S. Pat Pub. Nos. 2015337067 and 20200148798 to Henkel. Representative polyisobutylene vinyl ethers are described in Polymer Bulletin, Vol. 25, pp. 633 (1991), J. P. Kennedy, and in U.S. Pat. Nos. 6,054,549, 670,677,962 to Dow Corning Corp. Preferred (meth)acrylate functionalized polyisobutylene may be a free radical reactive polyisobutylene, a butyl rubber derivative, and like, which are terminated or grafted with (meth)acrylic or alpha-olefin functional groups. Particularly, the (meth)acrylate functionalized polyisobutylene has (i) a Mw of from about 1,000 to about 95,000 Da and/or (ii) contains greater than one free-radical reactive functional group per polymer chain. The (meth)acrylate functionalized polyisobutylene may comprise a functional group selected from one or more of terminal methacrylate, pendant methacrylate, terminal acrylate, and/or pendant acrylate.

Polyisobutylene refers to a polymer having a polyisobutylene skeleton containing a repeating unit represented by the following formula (A-1).

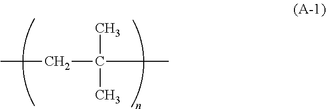

Further, in the present specification, the term “polymer” is not limited, and may be a compound having a structure having two or more repeating monomer units in the molecule, such as in a main chain.

Some useful polyisobutylene (meth)acrylate oligomers include, but are not limited to, acryloyl-terminated polyisobutylene (Kaneka Epion EP400V), polystyrene-polyisobutene-polystyrene triblock copolymer (SIBSTAR 103T) and combinations thereof.

The polyisobutylene (meth)acrylate oligomers may be present in amounts of about 1% to about 15%, about 2% to about 15%, about 3% to about 15%, about 4% to about 15%, about 5% to about 15%, about 6% to about 15%, about 7% to about 15%, about 8% to about 15%, about 9% to about 15%, about 10% to about 15%, about 11% to about 15%, about 12% to about 15%, about 13% to about 15%, about 14% to about 15%, all percentages weight by total composition.

The polyisobutylene (meth)acrylate oligomers may be present in amounts of about 1% to about 10%, about 2% to about 10%, about 3% to about 10%, about 4% to about 10%, about 5% to about 10%, about 6% to about 10%, about 7% to about 10%, about 8% to about 10%, about 9% to about 10%, all percentages weight by total composition.

In one advantageous aspect, the polyisobutylene (meth)acrylate oligomer may be present desirably in the amount of about 5% to about 15% percentage weight by total composition.

### (Meth)Acrylate Monomer

The compositions of the present invention include a (meth)acrylate monomer.

Some useful (meth)acrylate monomers include, but are not limited to, N,N-dimethylacrylamide (NN-DMA), isobornyl acrylate (IBOA), isobornyl methacrylate (IBOMA), hydroxyethyl methacrylate phosphate (for example, Harcryl 1228), trimethylolpropane triacrylate (for example, Photomer 4006), tris-(2-hydroxyethyl)-isocyanurate triacrylate (for example, Sartomer SR368), bis[2-(methacryloyloxy)ethyl](for example, Kayamer PM-2), trimethylolpropane ethoxylate triacrylate (for example, Photomer 4154), (meth)acrylic acid, methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, cyclohexyl (meth)acrylate, n-heptyl (meth)acrylate, n-octyl (meth)acrylate, 2-ethylhexyl (meth)acrylate, nonyl (meth)acrylate, decyl (meth)acrylate, dodecyl (meth)acrylate, phenyl (meth)acrylate, tolyl (meth)acrylate, benzyl (meth)acrylate, 2-methoxyethyl (meth)acrylate, 3-methoxybutyl (meth)acrylate, 2-hydroxyethyl (meth)acrylate, 2-hydroxypropyl (meth)acrylate, stearyl (meth)acrylate, glycidyl (meth)acrylate, 2-aminoethyl (meth)acrylate, γ-(methacryloyloxypropyl)trimethoxysilane, (meth)acrylic acid-ethylene oxide adduct, trifluoromethylmethyl (meth)acrylate, 2-trifluoromethylethyl (meth)acrylate, 2-perfluoroethylethyl (meth)acrylate, 2-perfluoroethyl-2-perfluorobutylethyl (meth)acrylate, 2-perfluoroethyl (meth)acrylate, perfluoromethyl (meth)acrylate, diperfluoromethylmethyl (meth)acrylate, 2-perfluoromethyl-2-perfluoroethylmethyl (meth)acrylate, 2-perfluorohexylethyl (meth)acrylate, 2-perfluorodecylethyl (meth)acrylate, and 2-perfluorohexadecylethyl (meth)acrylate. In an advantageous aspect, the (meth)acrylate monomer may be polyethylene glycol diacrylate (for example, SR 259 (polyethylene glycol (200) diacrylate from Sartomer). Suitable multifunctional (meth)acrylates include, but are not limited to, polyethylene glycol di(meth)acrylate (PEG200 DMA), desirably triethyleneglycol di(meth)acrylate, hydroxypropyl(meth)acrylate, bisphenol-A di(meth)acrylates, such as ethoxylated bisphenol-A (meth)acrylate (“EBIPA” OR “EBIPMA”), and tetrahydrofuran(meth)acrylates and di(meth)acrylates, citronellyl acrylate and citronellyl methacrylate, hexanediol di(meth)acrylate (“HDDA” or “HDDMA”), trimethylol propane tri(meth)acrylate, tetrahydrodicyclopentadienyl(meth)acrylate, ethoxylated trimethylol propane triacrylate (“ETTA”), triethylene glycol diacrylate, triethylene glycol dimethacrylate (“TRIEGMA”), dipropylene glycol diacrylate, trimethylol propane tri(meth)acrylate, and combinations thereof.

In another advantageous aspect, the (meth)acrylate monomers desirably may include N,N-dimethylacrylamide (NN-DMA), isobornyl acrylate (IBOA), isobornyl methacrylate (IBOMA), hydroxyethyl methacrylate phosphate, trimethylolpropane triacrylate, tris-(2-hydroxyethyl)-isocyanurate triacrylate, bis[2-(methacryloyloxy)ethyl], trimethylolpropane ethoxylate triacrylate, and combinations thereof.

In one particularly advantageous aspect, (meth)acrylate monomer may be hydroxyethyl methacrylate phosphate.

In another advantageous aspect, (meth)acrylate monomers with an average molecular weight above a certain range may be selected. In yet another advantageous aspect, (meth)acrylate monomers with an average molecular weight of equal to or greater than 300 may be desirable.

The (meth)acrylate monomers may be present in amounts of about 50% to about 75%, about 55% to about 75%, about 60% to about 75%, about 65% to about 75%, and about 70% to about 75%, all percentages weight by total composition.

The (meth)acrylate monomers may be present in amounts of about 50% to about 65%, about 55% to about 65%, about 60% to about 65%, all percentages weight by total composition.

The (meth)acrylate monomers may be present in amounts of about 40% to about 75%, about 45% to about 75%, about 50% to about 75%, about 55% to about 75%, about 60% to about 75%, about 65% to about 75%, and about 70% to about 75%, all percentages weight by total composition.

The (meth)acrylate monomers may be present in amounts of about 40% to about 65%, about 45% to about 65%, about 50% to about 65%, about 55% to about 65%, about 60% to about 65%, all percentages weight by total composition.

The (meth)acrylate monomers may be present in amounts of about 40% to about 55%, about 45% to about 55%, about 50% to about 55%, all percentages weight by total composition.

The (meth)acrylate monomers may be present in the amount of about 40% to about 45%, percentage weight by total composition.

In one advantageous aspect, the (meth)acrylate monomer may be present desirably in the amount of about 50% to about 75% percentage weight by total composition.

In one advantageous aspect, the ratio of polybutadiene urethane acrylate oligomer to (meth)acrylate monomer may be from about 40:1 to about 1:1, about 35:1 to about 1:1, about 30:1 to about 1:1, about 25:1 to about 1:1, about 20:1 to about 1:1, about 15:1 to about 1:1, about 10:1 to about 1:1, about 5:1 to about 1:1.

In one advantageous aspect, the ratio of polybutadiene urethane acrylate oligomer to (meth)acrylate monomer may be from about 15:1 to about 1:1, about 14:1 to about 1:1, about 13:1 to about 1:1, about 12:1 to about 1:1, about 11:1 to about 1:1, about 10:1 to about 1:1, about 9:1 to about 1:1, about 8:1 to about 1:1, about 7:1, to about 1:1, about 6:1 to about 1:1, about 5:1 to about 1:1, about 4:1 to about 1:1, about 3:1 to about 1:1, about 2:1 to about 1:1.

### Polyurethane Acrylate Oligomers

The disclosed curable compositions include a polyurethane acrylate oligomer.

Some useful polyurethane acrylate oligomers include, but are not limited to, difunctional aliphatic hydrophobic urethane acrylate oligomer (for example, BRC-441D), difunctional aliphatic hydrophobic urethane acrylate oligomer (for example, BRC-4421), difunctional aliphatic hydrophobic urethane acrylate oligomer (for example, BRC-443), difunctional aliphatic hydrophobic urethane acrylate (for example, BRC-443D), difunctional aliphatic hydrophobic urethane acrylate (for example, BRC-841), difunctional aliphatic hydrophobic urethane acrylate (for example, BRC-843), difunctional aliphatic hydrophobic urethane acrylate (for example, BRC-843D), difunctional aliphatic hydrophobic urethane acrylate (for example, BRC-843S), difunctional hydrophobic urethane acrylate (for example, BRC-843SD1), hydrophobic urethane acrylate oligomer (for example, BRC-8430E), difunctional aliphatic polyester urethane acrylate oligomer (for example, BR-441B120), hexafunctional aliphatic urethane acrylate oligomer (for example, BR-741), difunctional aliphatic polyester urethane methacrylate oligomer (for example, BR-741MD1), difunctional aliphatic polyester urethane methacrylate oligomer (for example, BR-742M), difunctional aliphatic polyester urethane acrylate oligomer (for example, BR-742MS), difunctional aliphatic polyester urethane acrylate (for example, BR-742S), difunctional aliphatic polyester urethane acrylate oligomer (for example, BR-7432 GB), difunctional aliphatic polyester urethane methacrylate oligomer (for example, BR-7432G130), difunctional aliphatic polyester urethane acrylate oligomer (for example, BR-744BT), difunctional aliphatic polyester urethane acrylate (for example, BR-744SD), difunctional aliphatic polyester urethane acrylate (for example, BR-771F), difunctional aliphatic polyester urethane methacrylate oligomer (for example, XR-741MS), difunctional aliphatic polyether urethane methacrylate oligomer (for example, BR-1041 MB), difunctional aliphatic polyether urethane methacrylate oligomer (for example, BR-1043 MB), trifunctional aromatic polyether urethane methacrylate oligomer (for example, BR-116), trifunctional aliphatic polyether urethane acrylate oligomer (for example, BR-144B), trifunctional aliphatic polyether urethane acrylate oligomer (for example, BR-144H15), difunctional aromatic polyether urethane methacrylate (for example, BR-202), difunctional aromatic polyether urethane methacrylate oligomer (for example, BR-204), difunctional aromatic polyether urethane acrylate oligomer (for example, BR-302), difunctional aromatic polyether urethane acrylate (for example, BR-3042), difunctional aliphatic polyether urethane acrylate oligomer (for example, BR-344), difunctional aliphatic polyether urethane acrylate oligomer (for example, BR-345), functional aliphatic polyether urethane acrylate oligomer (for example, BR-3641AA), functional aliphatic polyether urethane acrylate oligomer (for example, BR-3641AJ), difunctional aliphatic polyether urethane acrylate oligomer (for example, BR-371B), difunctional aliphatic polyether urethane methacrylate oligomer (for example, BR-371MS), difunctional aliphatic polyether urethane acrylate oligomer (for example, BR-372), difunctional aliphatic polyether urethane acrylate oligomer (for example, BR-374), functional aliphatic polyether urethane acrylate oligomer (for example, BR-3741AJ), difunctional aliphatic polyether urethane acrylate oligomer (for example, BR-3747AE), difunctional aliphatic polyether urethane methacrylate oligomer (for example, BR-541 MB), difunctional aliphatic polyether urethane methacrylate (for example, BR-5413 MB), difunctional aliphatic polyether urethane acrylate oligomer (for example, BR-543), difunctional aliphatic polyether urethane methacrylate oligomer (for example, BR-543 MB), difunctional aliphatic polyether urethane acrylate oligomer (for example, BR-543TF), difunctional aliphatic polyether urethane methacrylate oligomer (for example, BR-551M), functional aliphatic polyether urethane methacrylate oligomer (for example, BR-551ME), difunctional aliphatic polyether urethane methacrylate oligomer (for example, BR-5541M), difunctional aliphatic polyether urethane acrylate (for example, BR-571), difunctional aliphatic polyether urethane methacrylate oligomer (for example, BR-571 MB), functional aliphatic polyether urethane acrylate oligomer (for example, BR-582E8), difunctional aliphatic polyether urethane methacrylate (for example, BR-581MT), functional aliphatic polyether urethane acrylate oligomer (for example, BR-582110), difunctional aliphatic polyether urethane acrylate oligomer (for example, BR-5825130), trifunctional aliphatic polyether urethane methacrylate oligomer (for example, XR-145S), 2-[[(butylamino)carbonyl]oxy]ethyl acrylate (for example, Photomer 4184), aliphatic urethane triacrylate (for example, Photomer 6008), aliphatic urethane diacrylate (for example, Photomer 6009), aliphatic urethane triacrylate (for example, Photomer 6010), aliphatic urethane triacrylate (for example, Photomer 6019), aliphatic urethane diacrylate (for example, Photomer 6024), aliphatic urethane diacrylate (for example, Photomer 6063), aliphatic urethane acrylate (for example, Photomer 6064), aliphatic urethane triacrylate (for example, Photomer 6184), aliphatic urethane diacrylate (for example, Photomer 6210), aliphatic urethane diacrylate (for example, Photomer 6215), aliphatic urethane diacrylate (for example, Photomer 6230), aliphatic urethane diacrylate (for example, Photomer 6620), aliphatic urethane hexaacrylate (for example, Photomer 6621), aliphatic urethane hexaacrylate (for example, Photomer 6628), aliphatic urethane diacrylate (for example, Photomer 6630), aliphatic urethane hexaacrylate (for example, Photomer 6631), aliphatic urethane diacrylate (for example, Photomer 6638), aliphatic urethane triacrylate (for example, Photomer 6639), aliphatic urethane triacrylate (for example, Photomer 6642), aliphatic urethane diacrylate (for example, Photomer 6643), aliphatic urethane diacrylate (for example, Photomer 6644), aliphatic urethane diacrylate (for example, Photomer 6645), aliphatic urethane tetraacrylate (for example, Photomer 6646), aliphatic urethane hexaacrylate (for example, Photomer 6690), aliphatic urethane hexaacrylate (for example, Photomer 6692), aliphatic urethane diacrylate (for example, Photomer 6891), aliphatic urethane triacrylate (for example, Photomer 6892), aromatic urethane 10 acrylate (for example, Photomer 6577), aromatic urethane tetra acrylate (for example, Photomer 6578), aromatic urethane diacrylate (for example, Photomer 6579), aromatic urethane diacrylate (for example, Photomer 6581), aromatic urethane diacrylate (for example, Photomer 6582), aromatic urethane hexaacrylate (for example, Photomer 6720) water dilutable urethane diacrylate (for example, Photomer AQUA 6901), water dilutable urethane diacrylate (for example, Photomer AQUA 6902), water dilutable urethane hexaacrylate (for example, Photomer AQUA 6903), and combinations thereof.

In one particularly advantageous aspect, the polyurethane acrylate oligomer may be a functional aliphatic polyether urethane acrylate oligomer.

The polyurethane acrylate oligomer may be present in amounts of about 1% to about 30%, about 5% to about 30%, about 10% to about 30%, about 15% to about 30%, about 20% to about 30%, about 25% to about 30%, all percentages weight by total composition.

The polyurethane acrylate oligomer may be present in amounts of about 1% to about 20%, about 5% to about 20%, about 10% to about 20%, about 15% to about 20%, all percentages weight by total composition.

The polyurethane acrylate oligomer may be present in amounts of about 1% to about 10%, about 2% to about 10%, about 3% to about 10%, about 4% to about 10%, about 5% to about 10%, about 6% to about 10%, about 7% to about 10%, about 8% to about 10%, about 9% to about 10%, all percentages weight by total composition.

In one advantageous aspect, the polyurethane acrylate oligomer may be present in the amount of about 4% to about 10% percentage weight by total composition.

### Light-Curable Polydimethylsiloxane Di-Functional (Meth)Acrylate Oligomer

The disclosed curable compositions include a light-curable polydimethylsiloxane di-functional (meth)acrylate oligomer.

Among the useful light-curable (polydimethylsiloxane di-functional (meth)acrylate oligomers of the present invention include, but are not limited to, functional polysiloxane (for example, BYK UV 3505), gamma-glycidoxypropyltrimethoxysilane (for example, Silquest A 187), methacryloxypropyltrimethoxysilane (for example, Silquest A 174), (3-acryloxypropyl)trimethoxysilane (for example, Dynasylan ACMO), and combinations thereof.

The light-curable polydimethylsiloxane di-functional (meth)acrylate oligomers may be present in amounts of about 0.1% to about 5%, about 0.5% to about 5%, about 1% to about 5%, about 1.5% to about 5%, about 2% to about 5%, about 2.5% to about 5%, about 3% to about 5%, about 3.5% to about 5%, about 4% to about 5%, about 4.5% to about 5%, all percentages weight by total composition.

### Photo-Curing System

In one advantageous aspect, the curable composition comprises a photo-curing system. The photo-curing system includes the use of one or more photoinitiators. Useful photoinitiators include, but are not limited to UV initiators, visible initiators, or a combination of UV and visible initiators. In one advantageous aspect, the photoinitiator may be a polymeric structure to which may be attached at least one chromophore that is excited by radiation in the UV light range or visible light range.

A variety of UV initiators may be employed in the compositions. UV initiators are generally effective in the 200 to 400 nm range, and particularly in the portion of the spectrum that borders on the invisible light and the visible portion just beyond this, e.g., >200 nm to about 390 nm.

Among the useful initiators that will respond to UV radiation to initiate and induce curing of the (meth)acryl functionalized curable component include, but are not limited to, benzophenone and substituted benzophenones, acetophenone and substituted acetophenones, benzoin and its alkyl esters, xanthone and substituted xanthones, phosphine oxides, diethoxyacetophenone, benzoin methylether, benzoin ethylether, benzoin isopropylether, diethoxyxanthone, chlorothioxanthone, N-methyldiethanol-amine-benzophenone, 2-hydroxy-2methyl-1-phenyl-propan-1-one, 2-benzyl-2-(dimethylamino)-1-[4-(4-morpholinyl)phenyl]-1-butanone, and combinations thereof.

In one advantageous aspect, useful UV initiators include ethyl(2,4,6-trimethylbenzoyl)-phenyl phosphinate (for example, TPO-L), 1-hydroxycyclohexylphenylketone (for example, OMNIRAD 184),2-methyl-1-[4-(methylthio)phenyl]-2-morpholinopropan-1-one (for example, OMNIRAD 907), 2-benzyl-2-N,Ndimethylamino-1-(4-morpholinophenyl)-1-butanone (for example, OMNIRAD 369), the combination of 1-hydroxcyclohexyl phenylketone and benzophenone (for example, OMNIRAD 500), 2,2-dimethoxy-2-phenylacetophenone (for example, OMNIRAD 651), 1700 (the combination of bis(2,6-dimethoxybenzoyl-2,4,4-trimethylpentyl) phosphine oxide and 2-hydroxy-2-methyl-1-phenyl-propan-1-one) (for example, OMNIRAD 1700), bis(2,4,6,6-trimethylbenzoylphenyl phosphine oxide (for example, OMNIRAD 819), (2-hydroxy-2-methyl-1-phenyl-1-propane) (DAROCUR 1173), the combination of 2,4,6-trimethylbenzoyldiphenyl-phosphineoxide and 2-hydroxy-2-methyl-1phenyl-propan-1-one (for example, DAROCUR 4365), 2,4,6-trimethylbenzoyldiphenylphosphine oxide (for example, LUCIRIN TPO), Norrish Type II photoinitiators, and combinations thereof.

Generally, Norrish Type II photoinitiators pertain to photoinitiators which generate free radicals based on hydrogen abstraction.

In one advantageous aspect, the Norrish Type II photoinitiators include carbonyl compounds including aromatic ketones and quinones, such as, for example, benzophenones, ketosulphones, thioxanthones, 1,2-diketones, anthraquinone, fluorenones, xanthones, acetophenone derivatives, benzoin ethers, benzyl ketals, phenylglyoxylates, mono- and bis-acylphosphine.

Visible light initiators suitable for use in the present invention include, but are not limited to, camphorquinone peroxyester initiators, 9-fluorene carboxylic acid peroxyesters, visible light [blue] photoinitiators, d1-camphorquinone, photoinitiators based on substituted titanocenes (for example, IRGACURE 784DC), and combinations thereof.

In one advantage of the invention, the photoinitiators may be present in amounts of about 1% to about 6%, about 2% to about 6%, about 3% to about 6%, about 4% to about 6%, and about 5% to about 6%, all percentages by weight of the total composition.

In another advantage of the invention, the photoinitiators are desirably present in an amount of about 1% to about 6% percentage by weight of the total composition.

### Additional Additives

Optional additives, such as, but not limited to, filler(s), catalyst(s), solvent(s), plasticizer(s), viscosity modifier(s), toughener(s), reactive and/or non-reactive diluent(s), flow agent(s), coupling agent(s) (e.g. silanes), adhesion promoter(s), humectant(s), tackifier(s), flame retardant(s), wetting agent(s), thixotropic and/or rheology agent(s) (e.g., fumed silica) aging and/or corrosion inhibitor(s), fluorescence additive(s), photosensitizer(s), coloring agent(s), accelerator(s), defoamer(s), stabilizer(s), antioxidant(s) and pigment(s), and combinations thereof may optionally be included in the curable compositions of the present disclosure.

If used, suitable fillers include organic and inorganic fillers. Inorganic fillers include silica, silicate, alumina, asbestos, barium sulphate, calcium carbonate, calcium fluoride, carbon black, clays, diatomaceous earth, feldspar, ferromagnetics, fly ash, glass fibers, gypsum, jute fiber, kaolin, lingnocellulosics, magnesium hydroxide, mica, microcrystalline cellulose, powdered metals, quartz, starch, talc, titanium dioxide, wood flour, wood fibers, and combinations thereof. Organic fillers include thermoplastic polymers such as polyvinylacetates, polyolefins, and nylon fibers.

Catalysts are optional but may be incorporated into the disclosed compositions in amounts useful in the formation of the one-part curable compositions. If used, some useful catalysts include organometallic catalysts, for example stannous octoate, dibutyltin dilaurate, and dibutyltin diacetate.

For example useful amounts of a catalyst include about 0.01 percent by weight to about 1.0 percent by weight of the total composition, and desirably in amounts of about 0.01 percent by weight to about 0.05 percent by weight of the total composition.

In a further aspect, the composition may be free of or substantially free of solvent. Solvents include, but are not limited to, water, organic solvents, including non-polar and polar solvents and combinations thereof, for example, hexane and water, hexane, n-heptane n-octane, cyclohexane, benzene, toluene, xylene, ethyl ether, tetrahydrofuran, ethyl acetate, methyl formate, dimethyl ketone, methylethyl ketone, trichloroethylene, monochlorobenzene, chloroform, carbon tetrachloride, perfluoroalkanes, and n-methyl-2-pyrrolidone (NMP).

The additional additives are incorporated in varying amounts in the composition to provide desired properties or benefits. Optional additives may be present in the amount of about 1.0% to about 15%, about 5% to about 15%, and about 10% to about 15%, all percentages by weight of the total composition.

In one advantageous aspect, the compositions of the present invention generally have a Shore D hardness of about 50 cPs to about 70 cPs, about 55 cPs to about 70 cPs, about 60 cPs to about 70 cPs, about 65 cPs to about 70 cPs.

In another advantageous aspect, the compositions of the present invention desirably have a Shore D hardness of about 50 cPs to about 70 cPs.

In one advantageous aspect, the compositions of the present invention generally have a viscosity at 25° C. of about 100 Mpa to about 4,000 Mpa, about 500 Mpa to about 4,000 Mpa, about 1,000 Mpa to about 4,000 Mpa, about 1,500 Mpa to about 4,000 Mpa, about 2,000 Mpa to about 4,000 Mpa, about 2,500 Mpa to about 4,000 Mpa, about 3,000 Mpa to about 4,000 Mpa, and about 3,500 Mpa to about 4,000 Mpa.

In one advantageous aspect, the compositions of the present invention generally have a viscosity at 25° C. of about 100 Mpa to about 1,000 Mpa, about 200 Mpa to about 1,000 Mpa, about 300 Mpa to about 1,000 Mpa, about 400 Mpa to about 1,000 Mpa, about 500 Mpa to about 1,000 Mpa, about 600 Mpa to about 1,000 Mpa, about 700 Mpa to about 1,000 Mpa, about 800 Mpa to about 1,000 Mpa, and about 900 Mpa to about 1,000 Mpa.

In another advantageous aspect, the compositions of the present invention desirably have a viscosity at 25° C. of about 100 Mpa to about 4,000 Mpa.

In one advantageous aspect, the compositions of the present invention, subsequent to cure, generally have a shrinkage volume of about 1% to about 4%, about 2% to about 4%, about 3% to about 4%.

In another advantageous aspect, the compositions of the present invention, subsequent to cure, desirably have a shrinkage volume of about 2% to about 4%.

In one advantageous aspect, the compositions of the present invention, subsequent to cure, exhibit an adhesion bonding strength of about 0.30 MPa to about 1.20 MPa between either two low surface energy substrates or a low surface energy substrate and a high surface energy substrate.

In one advantageous aspect, the compositions of the present invention, subsequent to cure, exhibit an adhesion bonding strength of about 0.30 MPa to about 1.20 MPa, about 0.40 MPa to about 1.20 MPa, about 0.50 MPa to about 1.20 MPa, about 0.60 MPa to about 1.20 MPa, about 0.70 MPa, to about 1.20 MPa, about 0.80 MPa to about 1.20 MPa, about 0.90 MPa to about 1.20 MPa, about 1.0 MPa to about 1.20 MPa, and about 1.1 MPa to about 1.20 Mpa, between either two low surface energy substrates or a low surface energy substrate and a high surface energy substrate.

In one advantageous aspect, the compositions of the present invention, subsequent to cure, exhibit an adhesion bonding strength of about 0.30 MPa to about 1.1 MPa, about 0.40 MPa to about 1.1 MPa, about 0.50 MPa to about 1.1 MPa, about 0.60 MPa to about 1.1 MPa, about 0.70 MPa, to about 1.1 MPa, about 0.80 MPa to about 1.1 MPa, about 0.90 MPa to about 1.1 MPa, and about 1.0 MPa to about 1.1 MPa, between either two low surface energy substrates or a low surface energy substrate and a high surface energy substrate.

In one advantageous aspect, the compositions of the present invention, subsequent to cure, exhibit an adhesion bonding strength of about 0.30 MPa to about 1.0 MPa, about 0.40 MPa to about 1.0 MPa, about 0.50 MPa to about 1.0 MPa, about 0.60 MPa to about 1.0 MPa, about 0.70 MPa, to about 1.0 MPa, about 0.80 MPa to about 1.0 MPa, and about 0.90 MPa to about 1.0 MPa, between either two low surface energy substrates or a low surface energy substrate and a high surface energy substrate.

In one advantageous aspect, the compositions of the present invention, subsequent to cure, exhibit an adhesive bond strength retention subsequent to heat and humidity exposure of at least about 30% to about greater than 100%.

In one advantageous aspect, the compositions of the present invention, subsequent to cure, exhibit an adhesive bond strength retention subsequent to heat and humidity exposure of at least about 30% to about 130%, about 35% to about 130%, about 40% to about 130%, about 45% to about 130%, about 50% to about 130%, about 55% to about 130%, about 60% to about 130%, about 65% to about 130%, about 70% to about 130%, about 75% to about 130%, 80% to about 130%, 85% to about 130%, about 90% to about 130%, about 95% to about 130%, about 100% to about 130%, about 105% to about 130%, about 110% to about 130%, about 115% to about 130%, about 120% to about 130%, or about 125% to about 130%, of its bond strength.

All references made to percentage(s) by weight herein refer to percentages by weight of the total composition.

### EMBODIMENTS

[Embodiment 1]A one-part, light-curable adhesive composition which exhibits high adhesion properties when bonded to low surface energy thermoplastic substrate(s) subsequent to cure, comprising:
a) a polybutadiene urethane acrylate oligomer present in an amount of about 10% to about 60% by weight;
b) a (meth)acrylate monomer present in an amount of about 50% to about 75% by weight;
c) a polyurethane acrylate oligomer;
d) a photo-curing system; and
e) a light-curable polydimethylsiloxane di-functional (meth)acrylate oligomer.

[Embodiment 2] The composition of Embodiment 1, wherein the thermoplastic substrate(s) are selected from the group consisting of low surface energy substrates, high surface energy substrates, and combinations thereof.

[Embodiment 3] The composition of any one of Embodiments 1-2, wherein subsequent to cure exhibits an adhesion bonding strength of about 0.30 MPa to about 1.20 MPa between either two low surface energy substrates or a low surface energy substrate and a high surface energy substrate.

[Embodiment 4] The composition of any one of Embodiments 1-3, wherein subsequent to cure, the adhesive bond strength subsequent to heat and humidity exposure retains at least about 30% to about 130% of its bond strength.

[Embodiment 5] The composition of any one of Embodiments 1-4, wherein the polybutadiene urethane acrylate oligomer is selected from the group consisting of di-functional polybutadiene acrylate resin, di-functional acrylate resin, di-functional aliphatic polybutadiene urethane acrylate oligomer, polybutadiene acrylate resin, polybutadiene methacrylate resin, and combinations thereof.

[Embodiment 6] The composition of any one of Embodiments 1-5, wherein the polybutadiene urethane acrylate oligomer is selected from the group consisting of di-functional polybutadiene acrylate resin, di-functional aliphatic polybutadiene urethane acrylate, and combinations thereof.

[Embodiment 7] The composition of any one of Embodiments 1-6, further comprising a polyisobutylene (meth)acrylate oligomer selected from the group consisting of acryloyl-terminated polyisobutylene, polystyrene-polyisobutene-polystyrene triblock copolymer, and combinations thereof.

[Embodiment 8] The composition of any one of Embodiments 1-7, wherein the (meth)acrylate monomer is selected from the group consisting of N,N-dimethylacrylamide (NN-DMA), isobornyl acrylate (IBOA), isobornyl methacrylate (IBOMA), hydroxyethyl methacrylate phosphate, trimethylolpropane triacrylate, Tris-(2-hydroxyethyl)-isocyanurate triacrylate, bis[2-(methacryloyloxy)ethyl], trimethylolpropane ethoxylate triacrylate, and combinations thereof.

[Embodiment 9] The composition of any one of Embodiments 1-8, wherein the polyurethane acrylate oligomer is selected from the group consisting of difunctional aliphatic hydrophobic urethane acrylate oligomer, difunctional aliphatic polyester urethane acrylate oligomer, hexafunctional aliphatic urethane acrylate oligomer, difunctional aliphatic polyester urethane methacrylate oligomer, difunctional aliphatic polyether urethane methacrylate oligomer, trifunctional aromatic polyether urethane methacrylate oligomer, trifunctional aliphatic polyether urethane acrylate oligomer, difunctional aromatic polyether urethane methacrylate, difunctional aromatic polyether urethane acrylate oligomer, difunctional aliphatic polyether urethane acrylate oligomer, functional aliphatic polyether urethane acrylate oligomer, functional aliphatic polyether urethane methacrylate oligomer, trifunctional aliphatic polyether urethane methacrylate oligomer, 2-[[(butylamino)carbonyl]oxy]ethyl acrylate, aliphatic urethane triacrylate, aliphatic urethane diacrylate, aliphatic urethane acrylate, aliphatic urethane hexaacrylate, aliphatic urethane tetraacrylate, aromatic urethane 10 acrylate, aromatic urethane tetra acrylate, aromatic urethane diacrylate, aromatic urethane hexaacrylate, water dilutable urethane diacrylate, water dilutable urethane hexaacrylate, and combinations thereof.

[Embodiment 10] The composition of any one of Embodiments 1-9, wherein the polyurethane acrylate oligomer is present in an amount of about 1% to about 30% by weight.

[Embodiment 11] The composition of any one of Embodiments 1-10, wherein the light-curable polydimethylsiloxane di-functional (meth)acrylate oligomer is selected from the group consisting of multi(meth)acrylate functionalized polydimethylsiloxane, gamma-glycidoxypropyltrimethoxysilane, methacryloxypropyltrimethoxysilane, (3-acryloxypropyl)trimethoxysilane, and combinations thereof.

[Embodiment 12] The composition of any one of Embodiments 1-11, wherein the light-curable polydimethylsiloxane di-functional (meth)acrylate oligomer is present in an amount of about 0.1% to about 5.0% by weight.

[Embodiment 13] The composition of any one of Embodiments 1-12, wherein the photocuring system comprises a photoinitiator present in an amount of about 1% to about 6% by weight.

[Embodiment 14] The composition of any one of Embodiments 1-13, wherein the photoinitiator is selected from the group consisting of ethyl(2,4,6-trimethylbenzoyl)-phenyl phosphinate, 1-hydroxycyclohexylphenylketone,2-methyl-1-[4-(methylthio)phenyl]-2-morpholinopropan-1-one, 2-benzyl-2-N,Ndimethylamino-1-(4-morpholinophenyl)-1-butanone, the combination of 1-hydroxcyclohexyl phenylketone and benzophenone, 2,2-dimethoxy-2-phenylacetophenone, 1700 (the combination of bis(2,6-dimethoxybenzoyl-2,4,4-trimethylpentyl) phosphine oxide and 2-hydroxy-2-methyl-1-phenyl-propan-1-one), bis(2,4,6,6-trimethylbenzoylphenyl phosphine oxide, (2-hydroxy-2-methyl-1-phenyl-1-propane), the combination of 2,4,6-trimethylbenzoyldiphenyl-phosphineoxide and 2-hydroxy-2-methyl-1phenyl-propan-1-one, and 2,4,6-trimethylbenzoyldiphenylphosphine oxide, Norrish Type II photoinitiators and combinations thereof.

[Embodiment 15] The composition of any one of Embodiments 1-14, wherein subsequent to cure exhibits a Shore D hardness of about 50 to about 70.

[Embodiment 16] The composition of any one of Embodiments 1-15, having a viscosity of about 100 Mpa to about 4,000 Mpa.

[Embodiment 17] The composition of any one of Embodiments 1-16, wherein the ratio of polybutadiene urethane acrylate oligomer to (meth)acrylate monomer by weight is from about 40 to 1 to about 1 to 1.

[Embodiment 18] The composition of any one of Embodiments 1-17, wherein subsequent to cure exhibits a shrinkage volume of about 2 to about 4.

[Embodiment 19] The composition of any one of Embodiments 1-18, further including one or more additives selected from the group consisting of filler, diluent, defoamer, pigment, coloring agent, plasticizer, viscosity modifier, toughener, coupling agent, adhesion promoter, humectant, tackifier, flame retardant, wetting agent, thixotropic and/or rheology agent aging and/or corrosion inhibitor, fluorescence additive, photosensitizer, accelerator, stabilizer, antioxidant, and combinations thereof.

[Embodiment 20] An article of manufacture made from the composition of any one of Embodiments 1-19.

[Embodiment 21] The article of any one of Embodiments 1-20, being free of added surface primer.

[Embodiment 22] The composition of any one of Embodiments 1-21, for use in tube bonding.

[Embodiment 23] The article of manufacture of any one of Embodiments 1-22, for use in medical procedures which require tubing.

[Embodiment 24] The article of manufacture of any one of Embodiments 1-23, selected from the group consisting of medical tubing, catheter tubing, IV tubing, drug delivery tubing, drainage tubing, gas flow tubing, cardiac tubing, guidewire tubing, medical film, coronary tubing, peripheral and neurovascular tubing, shaft tubing, pump tubing, and combinations thereof.

[Embodiment 25]A method of making a one-part, light-curable adhesive composition which exhibits high adhesion properties when bonded to thermoplastic substrate(s) subsequent to cure, comprising the steps of:
a) combining a polybutadiene urethane acrylate oligomer present in an amount of about 10% to about 60% by weight; with
b) optionally, a polyisobutylene (meth)acrylate oligomer present in an amount of about 5% to about 15% by weight;
c) a (meth)acrylate monomer present in an amount of about 50% to about 75% by weight;
d) a polyurethane acrylate oligomer;
e) a photo-curing system; and
f) a light-curable polydimethylsiloxane di-functional (meth)acrylate oligomer.

[Embodiment 26] An article of manufacture having a coating or an adhesive joint comprising the composition of any one of Embodiments 1-25.

[Embodiment 27] The cured reaction product of the composition of any one of Embodiments 1-26.

[Embodiment 28] An article of manufacture comprising:
a) a first substrate surface; and
b) a second substrate surface, wherein said first and second substrate surfaces being joined by an adhesive composition comprising the composition of any one of Embodiments 1-27.

[Embodiment 29] The article of manufacture of Embodiment 28, wherein the first and the second substrate surfaces are selected from the group consisting of thermoplastic elastomer, polyvinylchloride (PVC), polycarbonate (PC), and combinations thereof.

[Embodiment 30]A process of depositing a one-part, light-curable adhesive composition which exhibits high adhesion properties when bonded to thermoplastic substrate(s) subsequent to cure, comprising the steps of:
a) combining a polybutadiene urethane acrylate oligomer present in an amount of about 10% to about 60% by weight;
b) optionally, a polyisobutylene (meth)acrylate oligomer present in an amount of about 5% to about 15% by weight;
c) a (meth)acrylate monomer present in an amount of about 50% to about 75% by weight;
d) a polyurethane acrylate oligomer;
e) a photo-curing system; and
f) a light-curable polydimethylsiloxane di-functional (meth)acrylate oligomer;
g) depositing the composition on the substrate to form one or more of a seal, a coating or a bond; and
h) curing the composition by exposure to UV light.

[Embodiment 31] The process of Embodiment 30, wherein the thermoplastic substrate(s) are selected from the group consisting of thermoplastic elastomer, polyvinylchloride (PVC), polycarbonate (PC), and combinations thereof.

[Embodiment 32]A one-part, light-curable adhesive composition which exhibits high adhesion properties when bonded to thermoplastic substrate(s) subsequent to cure, comprising:
a) a di-functional polybutadiene acrylate resin present in an amount of about 1000 to about 600% by weight;
b) a combination of isobornyl acrylate (BOA), hydroxyethyl methacrylate phosphate, trimethylolpropane triacrylate, present in an amount of about 500 to about 750 by weight;
c) a functional aliphatic polyether urethane acrylate oligomer;
d) a photo-curing system; and
e) a multi (meth)acrylate functionalized polydimethylsiloxane.

### EXAMPLES

The following chemical names are used interchangeably in this disclosure.

Materials used in all the examples:

| Name | Chemical Name | Genus |
|---|---|---|
| IBOA | Isobornyl acrylate | (meth)acrylate monomer |
| Dymax Bomar BR-641E | Di-functional Polybutadiene | polybutadiene urethane |
| | Acrylate Resin | acrylate oligomer |
| Dymax Bomar BR-582E8 | Di-functional Acrylate Resin | polybutadiene urethane |
| | | acrylate oligomer |
| Photomer 4006 | Trimethylolpropane triacrylate | (meth)acrylate monomer |
| BYK UV 3505 | Functional Polysiloxane | polydimethylsiloxane di- |
| | | functional (meth)acrylate |
| | | oligomer |
| Silquest A 187 | gamma- | polydimethylsiloxane di- |
| | Glycidoxypropyltrimethoxysilane | functional (meth)acrylate |
| | | oligomer |
| Harcryl 1228 | Hydroxyethyl methacrylate | (meth)acrylate monomer |
| | phosphate *2- | |
| TPO-L | Ethyl(2,4,6-Trimethylbenzoyl)- | Photoinitiator |
| | phenyl phosphinate | |
| Tinopal OB CO | 2,5-thiophenediylbis(5-tert-butyl- | Fluorescence Additive |
| | 1,3-benzoxazole) | |

### Testing Methods

Examples 1-5 were evaluated according to the testing conditions described herein below.

### Disclosed Composition Preparation

All of the raw materials were weighted in mass (g), and mixed at 1,000 rpm for 2 minutes, at 2,350 rpm for 6 minutes, and then at 1,000 rpm for 2 minutes in a speed mixer.

### Tensile Lap Shear Strength

Tensile lap shear was tested per ASTM D882-02. Test substrates having a nominal length of not less than 150 mm, a nominal width of 6 mm, and a thickness of not greater than 1 mm were used. The substrates were cleaned with isopropyl alcohol to remove dirt and oils. The disclosed compositions were applied as an adhesive to a portion of the substrate surface and then covered with a second substrate surface to create a bonding area of 0.5 inches with no induced gap. The bonding area was then light cured for 30 seconds using Loctite CL30 LED 405 nm Flood with Controller with light intensity of 800 mW/cm2. The lap shear samples were tested on a lap shear pulling machine with a pulling speed of 0.05 inch/minute at room temperature. The tensile strength at maximum load was recorded. The provided strengths for each composition are an average of results for 5 lap shear specimens.

### Shear Strength of Adhesives Using Tube-Set

Materials: Tubing (40 mm length) and PVC Y Connector. Wipe all parts to be bonded with reagent grade Isopropyl Alcohol (IPA) wiped. Fill the bond-line, assemble and wipe fillet with cotton swab to remove excess uncured adhesive. Cure adhesive at 405 nm LED, 1000 mW/cm2, 10 sec (10 J/cm2) both sides (Measured with UV A/B Radiometer Dosimeter). Store samples at ambient conditions for 1 hour prior to testing. Clamp Y connector and tubing 0.25″ away from bond-line (hub opening). Test adhesion using a tensile test machine at 200 mm/min cross head speed.

### Ambient and Thermal Aging

In some examples, a polycarbonate test substrate and a test substrate were used as a pair. In some examples, a TPE test substrate and a test substrate were used as a pair. Each test substrate had a nominal length of not less than 150 mm, a nominal width of 6 mm, and a thickness of not greater than 1 mm. The substrates were cleaned with isopropyl alcohol to remove dirt and oils. The compositions were applied as an adhesive to a portion of the substrate surface and then covered with a second substrate surface to create a bonding area of 0.5 square inches with no induced gap. The bonding area was then light cured for 30 seconds using Loctite CL30 LED 405 nm Flood with Controller with light intensity of 800 mW/cm² directed through the polycarbonate substrate (in the TPE to PC examples) or TPE substrate (in the TPE-to-TPE examples). After 24 hours in room temperature, the tensile lap shear strengths were tested per ASTM D882-02. The lap shear samples were tested on a lap shear pulling machine with a pulling speed of 0.05 inch/minute at room temperature. The tensile strength at maximum load was recorded. The tensile lap shear strength test was conducted again after 4 weeks of heat exposure of one set of specimens at 40° C. and 98% humidity and other specimens at 60° C. The provided strengths for each composition are an average of results for 5 lap shear specimens.

### Viscosity

Viscosities were measured at 25° C. and a shear rate of 50 s⁻¹ using a cone and plate rheometer (Anton Paar).

### Shore D Hardness

Shore D samples were measured based on ASTM D2240. Sheets containing the disclosed composition were light-cured with Loctite CL30 LED 405 nm Flood with Controller at 800 mW/cm2 for 30 seconds. The light-cured sheets were cut into 25.4 mm long and 76.2 mm wide specimens, with at least 6.35 mm thicknesses. The light-cured sheets were placed on a horizontal surface. A durometer was held in a vertical position at least 12.7 mm from an edge of the specimen. The presser foot of the durometer was pressed in the surface of the specimen and the maximum reading prior to break was obtained.

### Volume and Linear Shrinkage

The volume and linear shrinkage of the disclosed compositions is determined by comparing the aggregate density of the two liquid components to the density of the mixed and polymerized solid form in accordance with ASTM D792.

### Depth of Cure

Specimens containing the disclosed composition were placed into an aluminum weighing dish and were light-cured using Loctite CL30 LED 405 nm Flood with Controller with light intensity of 1 W/cm2 for 10 seconds. After cure, the specimens were allowed to cool to room temperature. The cooled, light-cured specimens were removed from the aluminum weighing dish and any uncured or gelled portion of the specimen was scraped off. The final thickness of the cured portion of the specimen was measured using a dial micrometer.

The chemical composition of Example 1 is shown in Table 1 below. Amounts are in wt. %. AA-3951 is a commercial adhesive composition comprising acrylated urethane.

TABLE 1

| Ingredients | Example 1 |
|---|---|
| (meth)acrylate monomer¹ | 60.95% |
| Additive² | 0.05% |
| Photoinitiator³ | 4.0% |
| Polydimethylsiloxane di-functional (meth)acrylate oligomer⁴ | 1.0% |
| Polybutadiene urethane acrylate oligomer⁵ | 28.0% |
| Polyurethane acrylate oligomer⁶ BOMAR BR-582E8 | 4.0% |
| (meth)acrylate monomer⁷ | 1.0% |
| (meth)acrylate monomer⁸ | 1.0% |
| Total | 100% |

¹Sipomer IBOA HP
²Tinopal OB CO
³Omnirad TPO-L
⁴BYK-UV 3505
⁵BOMAR TM BR-641E
⁶BOMAR BR-582E8
⁷Harcryl 1228
⁸Photomer 4006

The above-described mechanical property testing mechanisms were conducted on the commercial adhesive composition (AA-3951) and compared to the disclosed adhesive composition (Sample 1). The results are illustrated in Table 2 below.

TABLE 2

| Test | Example 1 | AA-3951 |
|---|---|---|
| Viscosity 50 s-1 25° C. (cPs) | 637.1 | 135.8 |
| Shore D Hardness | 62.2 | 60.6 |
| Elongation (%) | 90.7 | 236 |

### Example 1

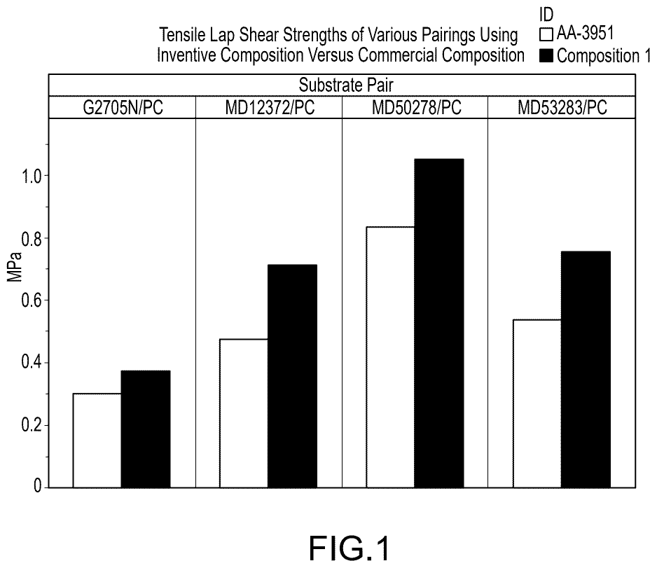

Example 1 compared the adhesion bonding strength using the Tensile Lap Shear Strength test of the Example adhesive composition to a commercial adhesive composition (AA-3951) bonded to the following substrate combinations: TPE MD53283 to polycarbonate, TPE G2705N to polycarbonate, TPE MD12372 to polycarbonate, and TPE MD50278 to polycarbonate. FIG. 1 and Table 3 illustrate the significant difference in adhesion bonding strength between the commercial and Example compositions as measured by MPa's.

TABLE 3
Strength Adhesion of Various TPE's w/Polycarbonate

| | Composition/Substrates | | | |
|---|---|---|---|---|
| | MD53283/ | G2705N/ | MD12372/ | MD50278/ |
| | PC | PC | PC | PC |
| AA-3951 | 0.536 (MPa) | 0.302 (MPa) | 0.476 (MPa) | 0.833 (MPa) |
| Example 1 | 0.754 (MPa) | 0.372 (MPa) | 0.713 (MPa) | 1.05 (MPa) |

As can be seen in Table 3, the Example composition has a stronger adhesion bonding strength as compared to the commercial composition.

### Example 2

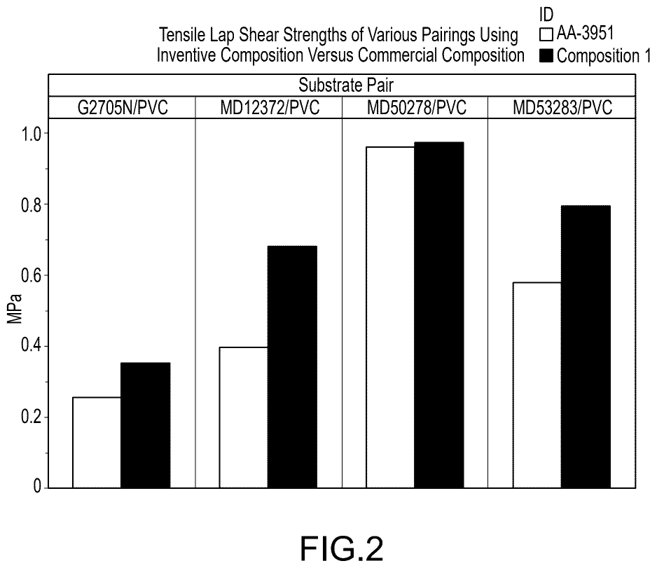

Example 2 compared the adhesion bonding strength using the Lap Shear Strength test of the Example adhesive composition to a commercial adhesive composition (AA-3951) bonded to the following substrate combinations: TPE MD53283 to TPE MD53283, TPE G2705N to TPE G2705N, TPE MD12372 to TPE MD12372, and TPE MD50278 to TPE MD50278. FIG. 2 and Table 4 illustrate the significant difference in adhesion bonding strength between the commercial and Example compositions.

TABLE 4
Strength Adhesion of Various TPE's w/TPE's

| | Composition/Substrates | | | |
|---|---|---|---|---|
| | MD53283/ | G2705N/ | MD12372/ | MD50278/ |
| | MD53283 | G2705N | MD12372 | MD50278 |
| AA-3951 | 0.482 (MPa) | 0.142 (MPa) | 0.267 (MPa) | 0.713 (MPa) |
| Example 1 | 0.508 (MPa) | 0.319 (MPa) | 0.517 (MPa) | 0.559 (MPa) |

As can be seen in Table 4, the Example composition has a stronger adhesion bonding strength as compared to the commercial composition.

### Example 3

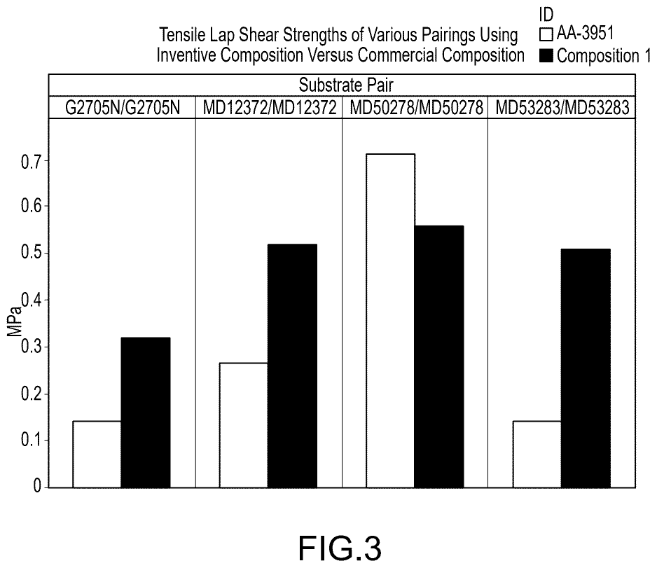

Example 3 compared the adhesion bonding strength using the Lap Shear Strength test of the Example adhesive composition to a commercial adhesive composition (AA-3951) bonded to the following substrate combinations: TPE MD53283 to Polyvinyl Chloride, TPE G2705N Polyvinyl Chloride, TPE MD12372 to Polyvinyl Chloride, and TPE MD50278 to Polyvinyl Chloride. FIG. 3 and Table 5 illustrate the significant difference in adhesion bonding strength between the commercial and disclosed compositions as measured by MPa's.

TABLE 5
Strength Adhesion of Various TPE's w/Polyvinylchloride

| | Composition/Substrates | | | |
|---|---|---|---|---|
| | MD53283/ | G2705N/ | MD12372/ | MD50278/ |
| | PVC | PVC | PVC | PVC |
| AA-3951 | 0.575 (MPa) | 0.256 (MPa) | 0.395 (MPa) | 0.958 (MPa) |
| Example 1 | 0.789 (MPa) | 0.354 (MPa) | 0.678 (MPa) | 0.969 (MPa) |

As can be seen in Table 5, the Example composition has a stronger adhesion bonding strength as compared to the commercial composition.

### Example 4

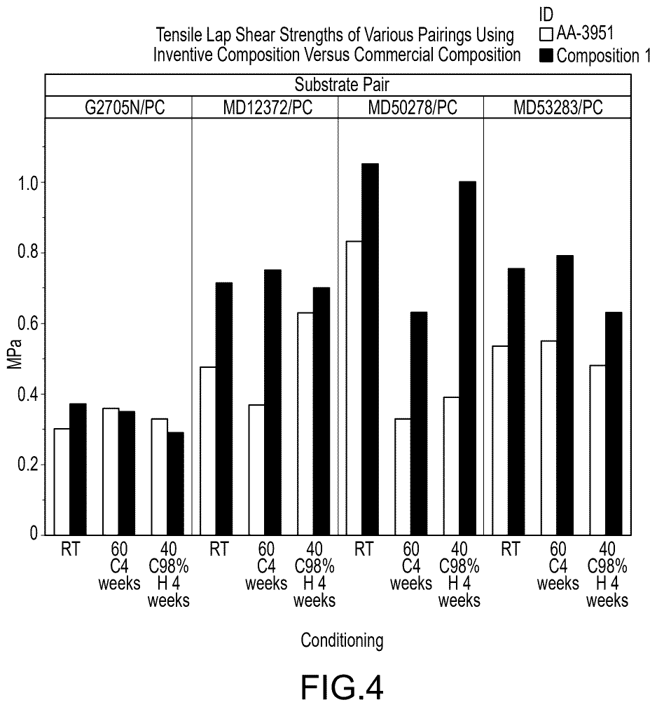

Example 4 compared the adhesion bonding strength retention using the Tensile Lap Shear Strength test of the Example adhesive composition to a commercial adhesive composition (AA-3951) bonded to the following substrate combinations: TPE MD53283 to polycarbonate, TPE G2705N to polycarbonate, TPE MD12372 to polycarbonate, and TPE MD50278 to polycarbonate. Each substrate pairing was subjected to i) an initial Tensile Lap Shear Strength test, ii) a Tensile Lap Shear Strength test after cured sample exposure to 60 degrees Celsius temperature for 4 weeks, and iii) a Tensile Lap Shear Strength test after cured sample exposure to 40 degrees Celsius temperature and 98% humidity for 4 weeks. FIG. 4 and Tables 6 and 7 illustrate that the cured Example composition, at its lowest retention %, retained at least 60% of its adhesion bonding strength as measured by MPa's, whereas the cured commercial composition possessed a low point retention % value of only 40%. In some cases, the Example composition retained adhesion bonding strength greater than 100%.

TABLE 6
Strength Adhesion Retention of Various TPE's w/Polycarbonate

| | Composition/Substrates | | | |
|---|---|---|---|---|
| | MD53283/ | G2705N/ | MD12372/ | MD50278/ |
| | PC | PC | PC | PC |
| AA-3951 Initial | 0.536 (MPa) | 0.302 (MPa) | 0.476 (MPa) | 0.833 (MPa) |
| After 4 weeks 60 | 0.550 (MPa) | 0.360 (MPa) | 0.370 (MPa) | 0.330 (MPa) |
| degrees Celsius | | | | |
| Calculated % Retention | >100% | >100% | 78% | 40% |
| Example 1 Initial | 0.754 (MPa) | 0.372 (MPa) | 0.713 (MPa) | 1.05 (MPa) |
| After 4 weeks 60 | 0.790 (MPa) | 0.350 (MPa) | 0.750 (MPa) | 0.630 (MPa) |
| degrees Celsius | | | | |
| Calculated % Retention | >100% | 94% | >100% | 60% |

As can be seen in Tables 6 and 7, the Example composition has an overall stronger adhesion bonding strength retention as compared to the commercial composition.

TABLE 7
Strength Adhesion Retention of Various TPE's w/Polycarbonate

| | Composition/Substrates | | | |
|---|---|---|---|---|
| | MD53283/ | G2705N/ | MD12372/ | MD50278/ |
| | PC | PC | PC | PC |
| AA-3951 Initial | 0.536 (MPa) | 0.302 (MPa) | 0.476 (MPa) | 0.833 (MPa) |
| After 4 weeks 40 degrees | 0.480 (MPa) | 0.330 (MPa) | 0.630 (MPa) | 0.390 (MPa) |
| Celsius 98% humidity | | | | |
| Calculated % Retention | 90% | >100% | >100% | 47% |
| Example 1 Initial | 0.754 (MPa) | 0.372 (MPa) | 0.713 (MPa) | 1.05 (MPa) |
| After 4 weeks 40 degrees | 0.630 (MPa) | 0.290 (MPa) | 0.700 (MPa) | 1.00 (MPa) |
| Celsius 98% humidity | | | | |
| Calculated % Retention | 84% | 78% | 98% | 95% |

### Example 5

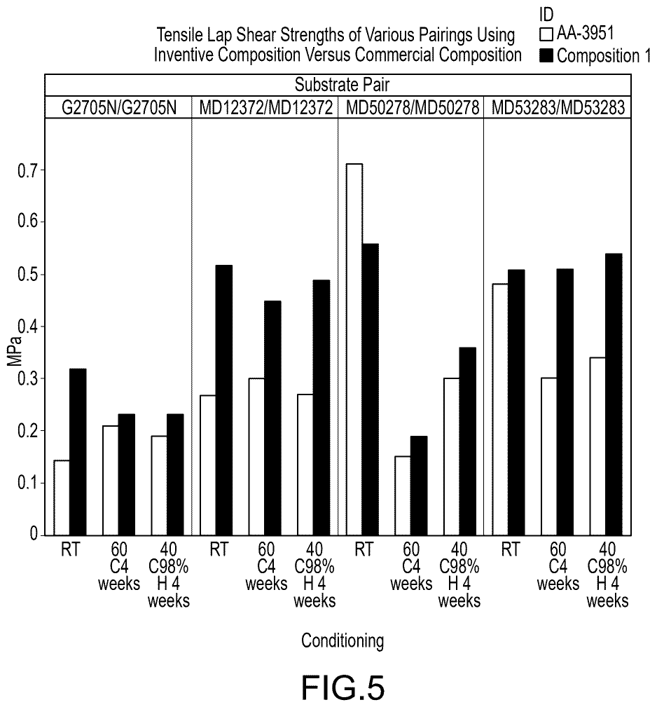

Example 5 compared the adhesion bonding strength retention using the Tensile Lap Shear Strength test of the Example adhesive composition to a commercial adhesive composition (AA-3951) bonded to the following substrate combinations: TPE MD53283 to TPE MD53283, TPE G2705N to TPE G2705N, TPE MD12372 to TPE MD12372, and TPE MD50278 to TPE MD50278. Each substrate pairing was subjected to i) an initial Tensile Lap Shear Strength test, ii) a Tensile Lap Shear Strength test after cured sample exposure to 60 degrees Celsius temperature for 4 weeks, and iii) a Tensile Lap Shear Strength test after cured sample exposure to 40 degrees Celsius temperature and 98% humidity for 4 weeks. FIG. 5 and Tables 8 and 9 illustrate that the Example composition at its lowest retention %, retained at least 34% of its adhesion bonding strength as measured by MPa's, whereas the commercial composition possessed a low point retention % value of only 21%. In some cases, the Example composition retained adhesion bonding strength greater than 100%.

TABLE 8
Strength Adhesion Retention of Various TPE's w/TPE's

| | Composition/Substrates | | | |
|---|---|---|---|---|
| | MD53283/ | G2705N/ | MD12372/ | MD50278/ |
| | MD53283 | G2705N | MD12372 | MD50278 |
| AA-3951 | 0.482 (MPa) | 0.142 (MPa) | 0.267 (MPa) | 0.713 (MPa) |
| Initial | | | | |
| After 4 weeks | 0.300 (MPa) | 0.210 (MPa) | 0.300 (MPa) | 0.150 (MPa) |
| 60 degrees | | | | |
| Celsius | | | | |
| Calculated % | 62% | >100% | >100% | 21% |
| Retention | | | | |
| Example 1 | 0.508 (MPa) | 0.319 (MPa) | 0.517 (MPa) | 0.559 (MPa) |
| Initial | | | | |
| After 4 weeks | 0.510 (MPa) | 0.230 (MPa) | 0.450 (MPa) | 0.190 (MPa) |
| 60 degrees | | | | |
| Celsius | | | | |
| Calculated % | >100% | 72% | 87% | 34% |
| Retention | | | | |

TABLE 9
Strength Adhesion Retention of Various TPE's w/TPE's

| | Composition/Substrates | | | |
|---|---|---|---|---|
| | MD53283/ | G2705N/ | MD12372/ | MD50278/ |
| | MD53283 | G2705N | MD12372 | MD50278 |
| AA-3951 | 0.482 (MPa) | 0.142 (MPa) | 0.267 (MPa) | 0.713 (MPa) |
| Initial | | | | |
| After 4 weeks | 0.340 (MPa) | 0.190 (MPa) | 0.270 (MPa) | 0.300 (MPa) |
| 40 degrees | | | | |
| Celsius | | | | |
| 98% humidity | | | | |
| Calculated % | 71% | >100% | >100% | 42% |
| Retention | | | | |
| Example 1 | 0.508 (MPa) | 0.319 (MPa) | 0.517 (MPa) | 0.559 (MPa) |
| Initial | | | | |
| After 4 weeks | 0.540 (MPa) | 0.230 (MPa) | 0.490 (MPa) | 0.360 (MPa) |
| 40 degrees | | | | |
| Celsius | | | | |
| 98% humidity | | | | |
| Calculated % | >100% | 72% | 95% | 64% |
| Retention | | | | |

As can be seen in Tables 8 and 9, the Example composition has an overall stronger adhesion bonding strength retention as compared to the commercial composition.

### Example 6

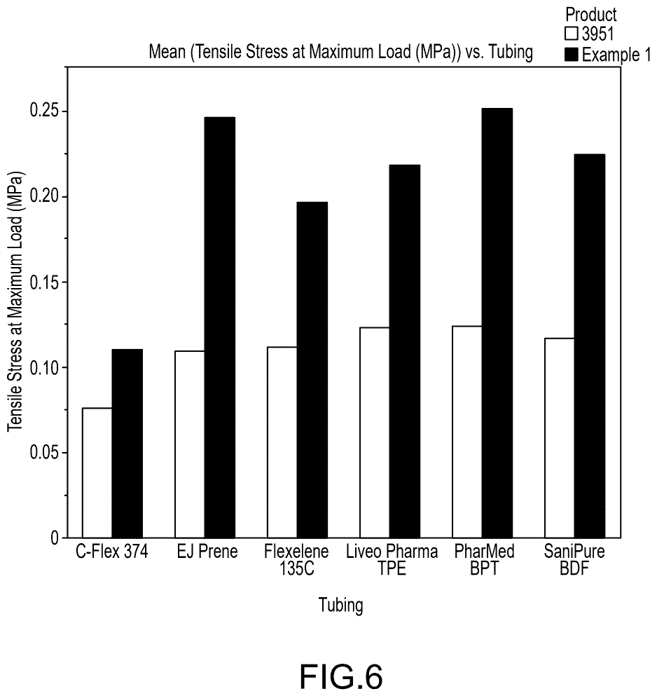

Example 6 compared the adhesion shear strength of various tubing materials bonded to a PVC Y connector using the Shear Strength of Adhesives Using Tube-set procedure. Results are shown in the Table below and FIG. 6. The results in Table 10 show the disclosed adhesives have a surprisingly improved bond strength to low surface energy tubing 1.4 to 2.2 times higher than the commercial AA-3951 adhesive.

TABLE 10
Shear Strength of Adhesives Using Tube-set

| Adhesive | Tubing | Tensile Stress at Maximum Load (MPa) |
|---|---|---|
| AA-3951 | Liveo Pharma TPE | 0.123 |
| AA-3951 | EJ Prene | 0.1093 |
| AA-3951 | C-Flex 374 | 0.0765 |
| AA-3951 | Flexelene 135C | 0.1115 |
| AA-3951 | SaniPure BDF | 0.1166 |
| AA-3951 | PharMed BPT | 0.1237 |
| Example 1 | Liveo Pharma TPE | 0.2179 |
| Example 1 | EJ Prene | 0.2459 |
| Example 1 | C-Flex 374 | 0.1104 |
| Example 1 | Flexelene 135C | 0.1959 |
| Example 1 | SaniPure BDF | 0.2236 |
| Example 1 | PharMed BPT | 0.2507 |

What is claimed is:

1. A one-part, light-curable adhesive composition which exhibits high adhesion properties when bonded to thermoplastic substrate(s) subsequent to cure, comprising:
a polybutadiene urethane acrylate oligomer present in an amount of about 10% to about 60% by weight;
a (meth)acrylate monomer present in an amount of about 50% to about 75% by weight;
a polyurethane acrylate oligomer;
a photo-curing system; and
a light-curable polydimethylsiloxane di-functional (meth)acrylate oligomer.

2. The composition of claim 1, wherein the thermoplastic substrate(s) are selected from the group consisting of low surface energy substrates, high surface energy substrates, and combinations thereof.

3. The composition of claim 1, wherein subsequent to cure exhibits an adhesion bonding strength of about 0.30 MPa to about 1.20 MPa between either two low surface energy substrates or a low surface energy substrate and a high surface energy substrate.

4. The composition of claim 2, wherein subsequent to cure, the adhesive bond strength subsequent to heat and humidity exposure retains at least about 30% to about 130% of its bond strength.

5. The composition of claim 1, wherein the polybutadiene urethane acrylate oligomer is selected from di-functional polybutadiene acrylate resin, di-functional aliphatic polybutadiene urethane acrylate oligomer, polybutadiene acrylate resin, polybutadiene methacrylate resin, and combinations thereof.

6. The composition of claim 1, wherein the polybutadiene urethane acrylate oligomer is selected from di-functional polybutadiene acrylate resin, aliphatic polybutadiene urethane acrylate, and combinations thereof.

7. The composition of claim 1, further comprising a polyisobutylene (meth)acrylate oligomer selected from acryloyl-terminated polyisobutylene, polystyrene-polyisobutene-polystyrene triblock copolymer, and combinations thereof.

8. The composition of claim 1, wherein the (meth)acrylate monomer is selected from N,N-dimethylacrylamide (NN-DMA), isobornyl acrylate (IBOA), isobornyl methacrylate (IBOMA), hydroxyethyl methacrylate phosphate, trimethylolpropane triacrylate, tris-(2-hydroxyethyl)-isocyanurate triacrylate, bis[2-(methacryloyloxy)ethyl], trimethylolpropane ethoxylate triacrylate, and combinations thereof.

9. The composition of claim 1, wherein the polyurethane acrylate oligomer is selected from difunctional aliphatic hydrophobic urethane acrylate oligomer, difunctional aliphatic polyester urethane acrylate oligomer, hexafunctional aliphatic urethane acrylate oligomer, difunctional aliphatic polyester urethane methacrylate oligomer, difunctional aliphatic polyether urethane methacrylate oligomer, trifunctional aromatic polyether urethane methacrylate oligomer, trifunctional aliphatic polyether urethane acrylate oligomer, difunctional aromatic polyether urethane methacrylate, difunctional aromatic polyether urethane acrylate oligomer, difunctional aliphatic polyether urethane acrylate oligomer, functional aliphatic polyether urethane acrylate oligomer, functional aliphatic polyether urethane methacrylate oligomer, trifunctional aliphatic polyether urethane methacrylate oligomer, 2-[[(butylamino)carbonyl]oxy]ethyl acrylate, aliphatic urethane triacrylate, aliphatic urethane diacrylate, aliphatic urethane acrylate, aliphatic urethane hexaacrylate, aliphatic urethane tetraacrylate, aromatic urethane 10 acrylate, aromatic urethane tetra acrylate, aromatic urethane diacrylate, aromatic urethane hexaacrylate, water dilutable urethane diacrylate, water dilutable urethane hexaacrylate, and combinations thereof.

10. The composition of claim 1, wherein the polyurethane acrylate oligomer is present in an amount of about 1% to about 30% by weight.

11. The composition of claim 1, wherein the light-curable polydimethylsiloxane di-functional (meth)acrylate oligomer is selected from multi(meth)acrylate functionalized polydimethylsiloxane, gamma-glycidoxypropyltrimethoxysilane, methacryloxypropyltrimethoxysilane, (3-acryloxypropyl)trimethoxysilane, and combinations thereof.

12. The composition of claim 1, wherein the light-curable polydimethylsiloxane di-functional (meth)acrylate oligomer is present in an amount of about 0.1% to about 5.0% by weight.

13. The composition of claim 1, having a weight ratio of the polybutadiene urethane acrylate oligomer to the (meth)acrylate monomer from about 40 to 1 to about 1 to 1.

14. An article of manufacture made from the composition of claim 1.

15. The article of manufacture of claim 14, selected from the group consisting of medical tubing, catheter tubing, IV tubing, drug delivery tubing, drainage tubing, gas flow tubing, cardiac tubing, guidewire tubing, medical film, coronary tubing, peripheral and neurovascular tubing, shaft tubing, pump tubing, and combinations thereof.

16. The article of manufacture of claim 14, wherein the thermoplastic substrate(s) comprise one or more low surface energy substrates bonded together by the composition as-cured which exhibits an adhesion bonding strength of about 0.30 MPa to about 1.20 MPa between the two low surface energy substrates.

17. The article of manufacture of claim 16, wherein subsequent to cure, the adhesive bond strength subsequent to heat and humidity exposure retains at least about 30% to about 130% of its bond strength.

18. The article of manufacture of claim 17, selected from the group consisting of medical tubing, catheter tubing, IV tubing, drug delivery tubing, drainage tubing, gas flow tubing, cardiac tubing, guidewire tubing, medical film, coronary tubing, peripheral and neurovascular tubing, shaft tubing, pump tubing, and combinations thereof.

19. A method of making a one-part, light-curable adhesive composition which exhibits high adhesion properties when bonded to thermoplastic substrate(s) subsequent to cure, comprising the steps of combining:
about 10% to about 60% by weight polybutadiene urethane acrylate oligomer;
about 50% to about 75% by weight (meth)acrylate monomer;
a polyurethane acrylate oligomer;
a photo-curing system;
a light-curable polydimethylsiloxane di-functional (meth)acrylate oligomer; and
optionally, about 5% to about 15% by weight polyisobutylene (meth)acrylate oligomer.

20. An article of manufacture comprising:
a first substrate surface; and a second substrate surface,
wherein said first and second substrate surfaces are joined by an adhesive composition comprising the composition of claim 1.

21. The article of manufacture of claim 20, wherein the first and the second substrate surfaces are selected from the group consisting of thermoplastic elastomer, polyvinylchloride (PVC), polycarbonate (PC), and combinations thereof.

22. A one-part, light-curable adhesive composition which exhibits high adhesion properties when bonded to thermoplastic substrate(s) subsequent to cure, comprising:
a di-functional polybutadiene acrylate resin present in an amount of about 10% to about 60% by weight;
a combination of isobornyl acrylate (IBOA), hydroxyethyl methacrylate phosphate, trimethylolpropane triacrylate, present in an amount of about 50% to about 75% by weight;
a functional aliphatic polyether urethane acrylate oligomer;
a photo-curing system; and
a multi(meth)acrylate functionalized polydimethylsiloxane.
